(19) United States
(12) Patent Application Publication
(10) Pub. No.: US 2025/0388263 A1
(43) Pub. Date: Dec. 25, 2025

(54) Steering Rod and Sensor System for a Steer-by-Wire Steering System

(71) Applicant: Robert Bosch GmbH, Stuttgart (DE)

(72) Inventors: Stefan Kuntz, Flein (DE); Guenter Escher, Oberstdorf (DE)

(21) Appl. No.: 19/245,342

(22) Filed: Jun. 22, 2025

(30) Foreign Application Priority Data
Jun. 25, 2024 (DE) 10 2024 205 872.6

(51) Int. Cl. B62D 15/02; B62D 5/00; G01D 5/20

(52) U.S. Cl. CPC B62D 15/0225; B62D 5/001; G01D 5/2053; G01D 2205/24

(57) ABSTRACT

A steering rod for a steer-by-wire steering system is disclosed. The steering rod is designed to move in the axial direction over a distance S. The steering rod includes a first target lane with first conductive segments. Gaps exist between the first segments such that the first segments and gaps form a first pattern along the first target lane which repeats itself with a first period length p₁. The steering rod includes a second target lane with second conductive segments. Gaps exist between the second segments such that the second segments and gaps along the second target lane form a second pattern that repeats with a second period length p₂. The period lengths p₁ and p₂ are selected such that the least common multiple of the period lengths p₁ and p₂ is greater than or equal to the distance S.

This application claims priority under 35 U.S.C. § 119 to application no. DE 10 2024 205 872.6, filed on Jun. 25, 2024 in Germany, the disclosure of which is incorporated herein by reference in its entirety.

The disclosure relates to a steer-by-wire steering system and, in particular, to a linear sensor for determining the position of a steering rod or an individual wheel adjuster.

### BACKGROUND

Steer-by-wire steering systems are an advanced technology in automotive engineering in which the conventional mechanical connection between the steering wheel and the steering gear is replaced by electronic control systems. In a classic steering system, a steering rod transmits the rotational movement of the steering wheel directly to the wheels. In a steer-by-wire system, on the other hand, the movements of the steering wheel are detected by sensors and transmitted as electrical signals to a control computer. This processes the signals and controls the movement of the wheels using actuators. This allows feedback and steering assistance to be precisely adjusted, enabling better vehicle control and individual tuning of the steering characteristics.

The basic structure of a steer-by-wire system comprises several essential components. First, there are sensors on the steering wheel that detect the angle of rotation and torque. This information is forwarded to a central control computer, which calculates the desired direction and dynamics of travel. The control commands are then transmitted to electric actuators, which position the wheels accordingly. Another important component is the feedback system, which provides the driver with realistic feedback on road conditions by transmitting artificial forces back to the steering wheel.

A particular problem with steer-by-wire systems is determining the exact position of the steering rod or individual wheel adjusters after the vehicle has been restarted. While in a mechanical system the position of the steering rod is physically determined by its connection to the wheels, in a steer-by-wire system the position must be ascertained electronically after the system is switched on. This can be challenging, as sensors and control units do not initially have accurate information about the wheel position.

Sensors that ascertain the position based on the rotation of the steering system drive are ambiguous. The problem of ambiguity can be solved with a counting system that counts the number of rotations of the drive and uses this to ascertain the exact position of the steering rod. However, when the vehicle is turned off, the counter does not work. If the steering rod moves when the vehicle is switched off, for example because the wheels are moved in a workshop when the vehicle is lifted onto a lifting platform, the stored counter value becomes invalid as it no longer indicates the correct position of the steering rod.

For this reason, it is important to use a system for determining the position of the steering rod that enables unambiguous linear position measurement.

The disclosure is therefore based on the task of proposing a measuring method and a corresponding sensor system for steering a vehicle, with which the position of the steering rod or the individual wheel adjuster can be unambiguously determined.

The problem is solved according to the disclosure set forth below.

In the following, the term “steering rod” is used synonymously for steering rods in the actual sense, i.e., for steering two wheels, or in the sense of an individual wheel adjuster, i.e., for steering an individual wheel. The terms are therefore interchangeable.

### SUMMARY

According to a first aspect of the disclosure, this task is solved by a steering rod for a steer-by-wire steering system. The steering rod is designed to move axially over a distance S. The steering rod comprises a first target lane with first conductive segments, wherein there are gaps between the first segments so that the first segments and gaps along the first target lane form a first pattern that repeats with a first period length p₁. The steering rod further comprises a second target lane with second conductive segments, wherein there are gaps between the second segments so that the second segments and gaps along the second target lane form a second pattern that repeats with a second period length p₂.

The segments are rigidly connected to the steering rod and the target lanes extend parallel to each other and to the axial direction of the steering rod.

The period lengths p₁ and p₂ are chosen so that the least common multiple of the period lengths p₁ and p₂ is greater than or equal to the distance S.

The lowest common multiple is a mathematical term. The lowest common multiple of two integers m and n is the smallest positive natural number that is both a multiple of m and a multiple of n.

The period lengths p₁ and p₂ should be used in such a way that the positioning accuracy corresponds to the natural number range. For example, if the segments are 1.7 cm long, the length can be specified in millimeters as 17 mm. The same applies to the gaps between the segments. In this way, the period lengths p₁ and p₂ are always specified as whole/natural numbers, so that standard methods for ascertaining the lowest common multiple can be used.

By finding the lowest common multiple for the period lengths, the distance can be ascertained at which the overall pattern, i.e. the combination of the first and second patterns, repeats itself. This distance must be equal to or greater than the distance S so that each point on the distance S can be unambiguously assigned to one portion of the overall pattern.

The segments consist of a flat, non-ferromagnetic material. They are designed to receive an alternating magnetic field from an inductive sensor and emit a response alternating field.

Unlike the segments, the gaps between the segments should not be conductive in order to form a defined pattern in each target lane. The gaps can be the same size or different sizes in both target lanes. The same applies in principle to the segments. However, the segments and gaps in the target lanes must not be of equal size, as this would result in equal period lengths for the target lanes. For the disclosure to work, the period lengths p₁ and p₂ must be different. The division, whether the segments and/or gaps are of different lengths, plays a minor role.

The sensor system to be used comprises at least two receiver coils for each target lane. The magnetic response alternating field signals from the receiver coils can be used to ascertain the unambiguous position of the steering rod in the steering system due to their unambiguous assignment to the position on the steering rod.

This enables true power-on determination of the absolute position or relative position of the steering rod in relation to the sensor and thus to the vehicle without the aid of external sensors. The proposed steering rod thus fulfills the purpose of the disclosure.

In one embodiment, a number n of segments of the first target lane and a number m of segments of the second target lane are equal or differ by one.

In this embodiment, almost identical period lengths can be achieved with gaps of the same or approximately the same size. In this context, “almost identical” is a particular advantage, as a slight difference allows for a particularly long distance S before the overall pattern of the target lanes repeats itself.

However, it should be noted that the difference in period lengths should not be too small, as otherwise the sensor system may not be able to detect any difference between the periods due to its measurement accuracy. A good compromise can be found by choosing the length of the periods or the length of the segments and the gaps between them so that the overall pattern extends once over the entire distance S without repeating itself. This allows maximum utilization of the available installation space while maximizing the signal amplitude in the receiver coils and maximizing the robustness of the vernier calculation.

In one embodiment, a number n of segments of the first target lane and a number m of segments of the second target lane differ by m+1 or m−1. The first target lane therefore has n=2m+1 or n=2m−1 segments.

In this embodiment, one target lane has almost twice as many segments as the other. It is also important here that there are “almost twice” as many, as otherwise the overall pattern would repeat itself after just two of the smaller periods. This embodiment is particularly advantageous because it minimizes mutual electromagnetic interference between the two target lanes.

In one embodiment, the steering rod comprises a milled-out region, wherein the target lanes are positioned in the milled-out region.

Preferably, the target lanes should not protrude from the milled-out region. The width of the target lanes, especially when both target lanes are taken together, should therefore be less than or equal to the width of the milled-out region. When the target lanes are completely housed in the milled-out region, the steering rod with the target lanes can move freely under the sensor system. Furthermore, the sensor system can be positioned very close to the steering rod, which reduces the space required for the entire steering system.

In one embodiment, the segments of the target lanes are spaced apart from the steering rod using at least one spacer.

The target lanes can be arranged together with a common spacer on the steering rod or via several spacers. To save material, a separate spacer can be used for each segment.

In addition to its spacer function, the spacer can also serve as a protective device. The spacer is preferably made of plastic or another electrically non-conductive material so that it does not generate a magnetic response alternating field itself. The spacer also shields the steering rod below, so that the alternating magnetic field generated by the transmitter coil does not induce any current in the steering rod.

Furthermore, the spacer can also perform purely mechanical or connecting functions, so that the target lanes can be easily mounted or replaced if damaged, for example.

In one embodiment, the ratio of the length of the first segments in the axial direction of the steering rod to the first period length p₁ is between 30% and 70%. In addition or alternatively, the ratio of the length of the second segments in the axial direction of the steering rod to the second period length p₂ is between 30% and 70%.

Larger conductive zones usually result in a larger amplitude for the detection of a magnetic response alternating field signal. However, the segments should not be too large, as otherwise there is a risk that the gaps will be too small and the pattern will no longer be visible from the signal amplitude.

Tests have shown that 30% to 70% is a good value for the segment length to determine the steering rod position.

In another aspect, the disclosure relates to a sensor system for ascertaining the position of a steering rod, as described above.

The sensor system comprises a transmitter coil, a first receiver coil system, and a second receiver coil system. The transmitter coil is set up to be energized by an alternating electric field signal.

The first receiver coil system comprises at least two first receiver coils, each of which is set up to receive a first alternating magnetic field signal emanating from the first target lane of the steering rod. The second receiver coil system comprises at least two second receiver coils, which are set up to each receive a second alternating magnetic field signal emanating from the second target lane.

The sensor system is designed to ascertain a first angle φ₁ from the first alternating magnetic field signal and a second angle φ₂ from the second alternating magnetic field signal. The sensor system is also designed to ascertain an unambiguous position of the steering rod relative to the sensor system over the distance S from the first angle φ₁ and the second angle φ₂.

The sensor system is preferably connected to a steering system housing or to the vehicle body so that the relative position ascertained by it is equal to an absolute position within the vehicle.

The sensor system also comprises means for demodulating the received alternating magnetic field signals and subsequently processing them. The sensor system may also comprise means for determining the position itself or for transferring the demodulated and, if necessary, preprocessed alternating field signals to a control unit or an on-board computer.

The receiver coil system comprises a total of at least four coils. Two first receiver coils and two second receiver coils. The first receiver coils interact with the segments of the first target lane, whereas the second receiver coils interact with the segments of the second target lane.

For interaction, the steering rod moves with the target lanes under the sensor system. The transmitter coil is energized and transmits an alternating magnetic field, which induces eddy currents in the segments beneath the transmitter coil, which in turn generate their own alternating magnetic field signals. These response alternating magnetic field signals are detected by the receiver coils of the respective lane, from which the overall position of the steering rod can be derived. The proposed sensor system thus fulfills the purpose of the disclosure.

In one embodiment, the sensor system can be connected via a plug connection to a control system for reading out the sensor data.

The influence of vibrations or forces on the sensor system that could impair determining of the position can be reduced by decoupling external systems from the sensor system. The sensor system is therefore preferably not connected directly, but via a plug connector to an evaluation system. In a further embodiment, the sensor system can be connected to an evaluating control or computing unit via a wireless communication interface.

In one embodiment, the sensor system comprises a return element, wherein the return element is designed to press the sensor system against the steering rod.

The accuracy of the sensor and determining of the position increases when the relative position between the sensor system and the steering rod is determined solely by the movement of the steering rod due to the steering movement. Effects such as vibrations or other external effects can be reduced by pressing the sensor system against the steering rods. Pressing down can also ensure that the air gap between the target lanes and the sensor system remains constant. The return element can preferably be designed as a pressure spring.

In one embodiment, the transmitter coil surrounds the receiver coils. The windings of the transmitter coil and the windings of the receiver coils are aligned parallel to the flat segments of the target lanes.

The transmitter coil generates an alternating magnetic field that should strike the target lanes as perpendicularly as possible in order to induce the strongest possible eddy currents there. Ideally, the windings of the transmitter coil should therefore be aligned perpendicular to the surface normal of the target lanes.

The induced eddy currents flow in the surface of the target lanes. The moving charges in turn generate magnetic fields that protrude from the surface of the target lanes. These magnetic fields are detected by the at least one receiver coil. Due to the alignment of the magnetic fields, the windings of the receiver coils are also parallel to the surface of the target lanes and aligned.

The arrangement of the transmitter coil around the receiver coils has several advantages. Firstly, the response alternating magnetic field emitted by the target lanes is practically immeasurable due to the eddy currents outside the energized area, i.e., outside the region around the transmitter coil. Secondly, the installation space inside the transmitter coil is used and optimized so that the sensor can be kept compact overall.

In another aspect, the disclosure relates to a steer-by-wire steering system comprising a steering rod and a sensor as described above.

In another aspect, the disclosure relates to a method for measuring the position of a steering rod for a steering system as described above. The method comprises:
applying an alternating electric field signal to the transmitter coil;
detecting initial alternating magnetic field signals with the first receiver coils and ascertaining a first angle φ₁ based on the initial alternating magnetic field signals;
detecting second alternating magnetic field signals with the second receiver coils and ascertaining a second angle φ₂ based on the second alternating magnetic field signals; and
ascertaining the unambiguous position of the steering rod along the distance S from the first angle φ₁ and the second angle φ₂.

The angles φ₁ and φ₂ can be ascertained from the response alternating magnetic field signals by adding the amplitudes of the signal voltages of the first receiver coils and the second receiver coils in the complex number space. Usually, amplitudes are defined without a sign and indicate the magnitude of a measurement. However, in the context of this disclosure, the signs are important in order to correctly demodulate the received alternating field signals and determine the angles φ₁ and φ₂.

The signal from one receiver coil forms the entry on the x-axis and the other signal from the other receiver coil forms the entry on the y-axis. The angle between the resulting amplitude and one of the axes can be determined as φ₁ or φ₂.

The angles φ₁ and φ₂ each have a sawtooth pattern when viewed individually, while the steering rod moves under the sensor system. An angle alone would therefore not be meaningful. By combining the two angle positions, each point along the distance S can be assigned exactly one angle combination for the two angles φ₁ and φ₂. Due to the common pattern of the target lanes, which does not repeat itself over the distance S, the assignment between waypoint and angle combination is unambiguous. This allows the unambiguous position of the steering rod to be ascertained from the angles φ₁ and φ₂.

In one embodiment, ascertaining the first angle φ₁ and ascertaining the second angle φ₂ each comprise processing the received alternating magnetic field signals, in particular filtering, demodulating, digitizing, and/or transforming.

If more than two receiver coils are used per target lane, a signal transformation, such as a Clarke transformation, can be performed before the angles φ₁ and φ₂ are ascertained.

The processing of the received alternating field signals can be carried out by a control unit within the sensor system or by an external control unit that is communicatively coupled to the sensor system.

In one embodiment, the position of the steering rod is ascertained using the vernier principle.

The first target lane can be used to measure the position of the steering rod, but then, as described at the beginning, the problem of ambiguity arises. The second target lane can be used to resolve the ambiguity problem, as the second target lane returns a second pattern for each position of the steering rod over the distance S. The two patterns work together as a vernier principle, since when viewed together, they form a common overall pattern from which the position can be precisely determined. The accuracy of determining of the position depends on the size of the segments used in the target lanes and on the measurement accuracy of the alternating magnetic field signals.

Alternatively, for a large number of possible combinations, the angles φ₁ and φ₂ can be assigned a position of the steering rod, wherein the position of the steering rod is ascertained on the basis of a stored table. The table can be stored in a memory of the sensor system, for example. In particular, the table can comprise portions of angle combinations so that a separate value does not have to be stored for each individual angle.

In another aspect, the disclosure relates to a computer program with program code for carrying out a method as described above when the computer program is executed on a computer and/or a computer-readable data carrier with program code of a computer program for carrying out a method as described above when the computer program is executed on a computer.

In a further aspect, the disclosure relates to a system for measuring the position of a steering rod in a steer-by-wire steering system, wherein the system is designed to carry out a method as described above.

In total, therefore, a steering rod, a sensor system, a steer-by-wire steering system, a method for determining the position of the steering rod, a computer program and a computer-readable data carrier, as well as a system for carrying out the described method, are specified.

The described embodiments and refinements may be combined with one another as desired.

Further possible designs, refinements and implementations of the disclosure also comprise combinations of features of the disclosure described previously or below with regard to the exemplary embodiments that are not explicitly mentioned.

### BRIEF DESCRIPTION OF THE DRAWINGS

The accompanying drawings are intended to provide a better understanding of the embodiments of the disclosure. They illustrate embodiments and, in connection with the description, serve to explain principles and concepts of the disclosure.

Other embodiments and many of the advantages mentioned are shown in the drawings. The illustrated elements of the drawings are not necessarily shown to scale with respect to one another.

The figures show:

FIG. 1 shows a steering system with a steering rod according to an embodiment of the disclosure; and

FIG. 2 shows a sensor system and two target lanes according to one embodiment.

In the figures of the drawings, identical reference numbers denote identical or functionally identical elements, parts or components, unless stated otherwise.

### DETAILED DESCRIPTION

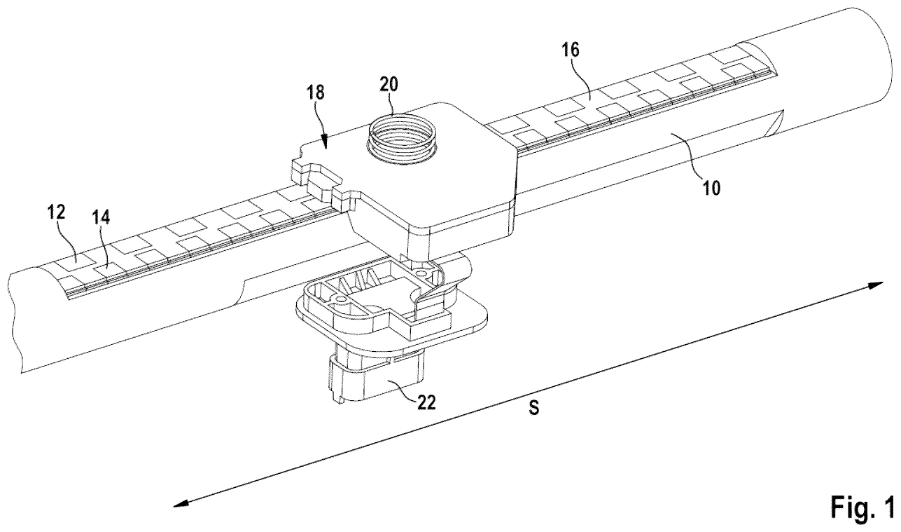

FIG. 1 shows a perspective view of a portion of a steering system with a steering rod 10. Two target lanes 12 and 14 are arranged on the steering rod and extend in the direction of extension of the steering rod 10. In the embodiment shown, target lanes 12 and 14 are connected to the steering rod 10 via a spacer 16. The spacer 16 is preferably made of a dielectric material, such as a plastic or ceramic, and secures the target lanes 12 and 14 to the steering rod 10.

Target lanes 12 and 14 each comprise several segments with gaps between them. The segments and gaps of a target lane 12, 14 are each of equal length within the target lanes 12, 14, so that a period p₁ and p₂ results for each target lane 12 and 14. Periods p₁ and p₂ are of different lengths, so that target lanes 12 and 14 comprise different numbers of segments.

Target lanes 12 and 14 together form a common pattern that does not repeat itself over the entire distance S that the steering rod 10 can move.

The steering rod 10 is designed to move under the sensor system 18. The sensor system 18 is an inductive sensor system that can detect a response alternating magnetic field signal from the target lanes 12, 14. Since each position of the steering rod 10 is assigned to an unambiguous region of the pattern of the target lanes 12, 14, the sensor system 18 can indirectly determine the position of the steering rod 10.

The sensor system 18 should not move if possible, and the steering rod 10 should also move as little as possible transversely to its direction of extension. In order to reduce relative movement of the steering rod 10 with respect to the sensor system 18, the sensor system 18 can be pressed against the steering rod by way of a return element. In the embodiment shown, the return element is designed as a pressure spring 20.

To further decouple vibrations and other disruptive influences, the sensor system 18 in the embodiment shown can be connected to evaluation electronics (not shown here) via a plug connector 22. The plug connector 22 is preferably not connected directly to the sensor system 18 so that any pull caused by cables or other effects is not transmitted to the sensor system 18 and thus does not make the determining of the position inaccurate.

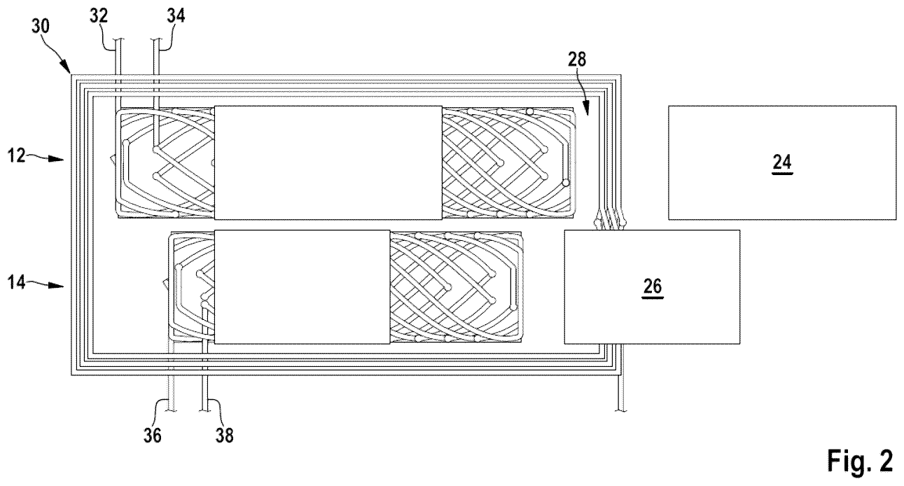

FIG. 2 shows a sensor system as seen from target lanes 12 and 14. In this embodiment, the target lanes 12, 14 are also formed by segments 24 and 26. Gaps 28 are arranged between segments 24 and 26 so that the sensor system can detect a pattern in the target lanes 12, 14 and determine the position of the steering rod from this.

The sensor system comprises a transmitter coil 30 and two receiver coil systems, each consisting of two receiver coils 32 and 34 or 36 and 38.

In the embodiment shown, the receiver coils 32, 34, 36, and 38 each form several loops with different field directions. The loops are arranged so that the field directions of adjacent loops are opposite to each other. Furthermore, the two receiver coils 32, 34 and 36, 38 of a receiver coil system are designed with different flow directions.

The transmitter coil 30 surrounds the receiver coils 32, 34, 36, 38, with all coils arranged in one plane. This arrangement of the coils allows the sensor system to be designed as compact as possible, which reduces the required installation space. In addition, the response alternating magnetic field signals outside the range of the transmitter coil 30 are very weak, making them impossible to measure in practice. The arrangement of the receiver coil systems within the transmitter coil 30 is therefore also useful for the accuracy of determining of the position.

What is claimed is:

1. A steering rod for a steer-by-wire steering system, wherein the steering rod is designed to move in an axial direction over a distance, the steering rod comprising:
a first target lane with first conductive segments, wherein there exists gaps between the first conductive segments so that the first conductive segments and the gaps form a first pattern along the first target lane that repeats with a first period length; and
a second target lane with second conductive segments, wherein there exists gaps between the second conductive segments so that the second conductive segments and the gaps form a second pattern along the second target lane that repeats with a second period length,
wherein the first conductive segments and the second conductive segments are rigidly connected to the steering rod and wherein the first target lane and the second target lane extend parallel to each other and to the axial direction of the steering rod, and
wherein the first period length and the second period length are selected such that the least common multiple of the first period length and the second period length is greater than or equal to the distance.

2. The steering rod according to claim 1, wherein a number n of segments of the first target lane and a number m of segments of the second target lane are equal in size or differ by one.

3. The steering rod according to claim 1, wherein a number n of segments of the first target lane and a number m of segments of the second target lane differ by m+1 or m−1.

4. The steering rod according to claim 1, wherein the steering rod comprises a milled-out region, and wherein the first target lane and the second target lane are positioned in the milled-out region.

5. The steering rod according to claim 1, wherein the first conductive segments and the second conductive segments of the first target lane and the second target lane are spaced apart from the steering rod by way of at least one spacer.

6. The steering rod according to claim 1, wherein the ratio of the length of the first conductive segments in the axial direction of the steering rod to the first period length is between 30% and 70% and/or wherein the ratio of the length of the second conductive segments in the axial direction of the steering rod to the second period length is between 30% and 70%.

7. A sensor system for ascertaining the position of a steering rod according to claim 1, comprising a transmitter coil, a first receiver coil system, and a second receiver coil system, wherein:
the transmitter coil is set up to be energized by an alternating electric field signal,
the first receiver coil system comprises at least two first receiver coils which are each set up to receive a first alternating magnetic field signal emanating from the first target lane of the steering rod,
the second receiver coil system comprises at least two second receiver coils which are each set up to receive a second alternating magnetic field signal emanating from the second target lane,
the sensor system is designed to ascertain a first angle from the first alternating magnetic field signal,
the sensor system is also designed to ascertain a second angle from the second alternating magnetic field signal, and
the sensor system is further designed to ascertain, from the first angle and the second angle, a position of the steering rod relative to the sensor system that is unambiguous over the distance.

8. The sensor system according to claim 7, wherein the sensor system is configured to be connected via a plug connection to a control system for reading out the sensor data.

9. The sensor system according to claim 7, wherein the sensor system comprises a return element, and wherein the return element is designed to press the sensor system against the steering rod.

10. The sensor system according to claim 7, wherein the transmitter coil surrounds the receiver coils and wherein the windings of the transmitter coil and the windings of the receiver coils are aligned parallel to the first conductive segments and the second conductive segments of the first target lane and the second target lane.

11. A steer-by-wire steering system comprising a steering rod according to claim 1.

12. A method for measuring position of a steering rod with a sensor, comprising:
applying an alternating electric field signal to a transmitter coil;
detecting initial alternating magnetic field signals with first receiver coils and ascertaining a first angle based on the initial alternating magnetic field signals;
detecting second alternating magnetic field signals with second receiver coils and ascertaining a second angle based on the second alternating magnetic field signals; and
ascertaining an unambiguous position of the steering rod along a distance from the first angle and the second angle.

13. The method according to claim 12, wherein ascertaining the first angle and ascertaining the second angle each comprise processing the received alternating magnetic field signals.

14. The method according to claim 12, wherein the position of the steering rod is ascertained using the vernier principle or wherein each combination of the value of the first angle with the value of the second angle is assigned a position of the steering rod and wherein the position of the steering rod is ascertained on the basis of a stored table.

15. A computer program with program code for carrying out the method according to claim 12 when the computer program is executed on a computer.

16. A system for measuring an absolute position of a steering rod in a steer-by-wire steering system according to claim 11.

17. A steer-by-wire steering system comprising a sensor system according to claim 7.

18. The method according to claim 13, wherein the processing includes filtering, demodulating, digitizing, and/or transforming.

19. A system for measuring an absolute position of a steering rod in a steer-by-wire steering system, wherein the system is designed to carry out the method according to claim 12.
